(19) United States
(12) Patent Application Publication
(10) Pub. No.: US 2026/0371422 A1
(43) Pub. Date: Nov. 19, 2026

(54) ASYMMETRIC MULTI-LINK WI-FI OPERATION

(71) Applicant: NETGEAR, INC., San Jose, CA (US)

(72) Inventors: Natarajan Chidambaram, Dublin, CA (US); Manjunathaharsha Nagaraju, San Jose, CA (US)

(21) Appl. No.: 19/208,049

(22) Filed: May 14, 2025

(51) Int. Cl. H04W 76/15; H04L 5/14; H04W 84/12

(52) U.S. Cl. CPC H04W 76/15; H04L 5/14; H04W 84/12

(57) ABSTRACT

A wireless communication system establishes separate radio links for uplink and downlink traffic, dedicating wider bandwidth channels for downlink transmission while using narrower bandwidth channels for uplink communication. The separation creates a full-duplex-like environment, which is compatible with existing Wi-Fi infrastructure. The wireless communication system provides traffic management and failover mechanisms to meet performance targets across varying network conditions.

### BACKGROUND

Wireless communication systems have evolved significantly since the introduction of Wi-Fi, with each new generation bringing improvements in speed, efficiency, and/or connectivity. Modern Wi-Fi systems can operate across multiple frequency bands including 2.4 Gigahertz (GHz), 5 GHz, and/or 6 GHz, with each band offering different characteristics in terms of range and bandwidth. Multi-link operation (MLO) was introduced recently to enable devices to simultaneously send and receive data across different frequency bands and channels, improving throughput and reducing latency. However, existing implementations of MLO do not fully address the inherent limitations of half-duplex communication in wireless networks.

### BRIEF DESCRIPTION OF THE DRAWINGS

Detailed descriptions of implementations of the present technology will be described and explained through the use of the accompanying drawings.

FIG. 1 is a block diagram that illustrates an example system that can implement aspects of the present technology.

FIG. 2 is a block diagram that illustrates an example system that can implement aspects of the present technology.

FIG. 3 is a flow diagram that illustrates an example process that performs aspects of the present technology.

FIG. 4 is a flow diagram that illustrates an example process that performs aspects of the present technology.

FIG. 5 is a drawing that illustrates example Wi-Fi beacon extensions.

FIG. 6 is a flow diagram that illustrates an example process that performs aspects of the present technology.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The wireless communication landscape has evolved with increasing demands for higher speeds and lower latency. While Wi-Fi technology has made significant strides, the fundamental challenge of half-duplex communication continues to impact performance. In half-duplex communication, data transmission can occur in both directions, but not simultaneously. Devices take turns sending and receiving data, similar to walkie-talkies. This limits speed and efficiency compared to full-duplex systems, as only one device can transmit or receive at a time on the same frequency channel. Traditional Wi-Fi systems typically cannot simultaneously transmit and receive data on the same channel, leading to reduced efficiency. Previous approaches to improving Wi-Fi performance focused on various traffic control mechanisms and channel management techniques. Wi-Fi 7 introduced multi-link operation (MLO) to allow simultaneous use of multiple frequency bands, representing a significant advancement. However, conventional MLO implementations maintain bidirectional traffic on each link, still subject to half-duplex limitations.

This document discloses methods, systems and apparatuses for asymmetric multi-link wireless communication. The disclosed methods present an innovative approach to MLO by implementing asymmetric traffic distribution. By dedicating specific radio links for either uplink or downlink traffic, the methods create a full-duplex-like environment without the traditional limitations of half-duplex communication. This approach particularly benefits from using wider bandwidth bands like 6 Gigahertz (GHz) for download-heavy traffic while utilizing smaller bandwidth bands like 2.4 GHz for acknowledgments and control signals. The disclosed systems leverage the capabilities of Wi-Fi 7 MLO and enhance it through traffic separation. This separation allows for more efficient use of available spectrum, with high-bandwidth applications like streaming utilizing the wider channels while control traffic flows through narrower bands. The system can maintain a single authentication process across both links while operating them asymmetrically.

The disclosed implementations can perform coordination between access points and client devices. For example, the disclosed apparatuses manage quality of service across separated uplink and downlink paths while maintaining the ability to fall back to traditional operation if needed. This flexibility provides more robust performance across varying network conditions compared to traditional methods. The apparatuses' architecture is compatible with existing Wi-Fi infrastructure and different usage patterns. By improving the use of available spectrum and reducing contention, the disclosed systems provide a more efficient and reliable wireless communication solution compared to traditional methods.

In some implementations, an access point initiates a process of establishing a multi-link connection with a compatible client device using at least two radio links. The connection can be established using Wi-Fi 7 MLO protocols, which combine links across different bands to create a unified, high-speed connection. The connection phase can involve detecting if the client device supports asymmetric MLO. A single authentication process can be used to authorize the client device for communication across multiple radio links, simplifying security management and reducing overhead. This multi-link connection, enabling simultaneous communication across different frequency bands, is established before the asymmetric traffic distribution is configured. The access point can establish separate uplink and downlink paths using different radio links. The downlink path utilizes a wider bandwidth frequency band, typically 6 GHz, for high-throughput applications like streaming media. The uplink path operates on a separate, narrower bandwidth band for acknowledgments and control signals. This separation enables simultaneous transmission and reception without traditional half-duplex limitations.

In some implementations, an access point determines that a client device supports asymmetric MLO. The access point establishes a multi-link connection with the client device using at least two radio links. The access point can configure a first radio link to operate at a first frequency band, designated for downlink transmission. Simultaneously, a second radio link is configured for exclusive uplink transmission, operating at a second frequency band that is different from the first. This typically involves using a wider band like 5 or 6 GHz for downlink and a narrower band like 2.4 GHz for uplink. Traffic routing rules can be employed to direct downlink traffic, such as streaming media content, to the designated first radio link, while directing uplink traffic, like acknowledgment messages and control signals, exclusively to the configured second radio link. The access point can monitor performance metrics of both links. Through the simultaneous use of these separate links, the access point performs bidirectional communication with the client device, with the downlink traffic separated from the uplink traffic. This separation effectively creates a full-duplex-like environment. The access point can maintain quality of service parameters across both paths while improving overall network performance.

In some implementations, an access point provides failover mechanisms and flexibility in operation. If either the uplink or downlink path experiences interference or becomes unavailable, the computer system can dynamically transition to traditional bidirectional operation on the remaining link. This adaptability provides uninterrupted connectivity while achieving performance metrics when possible.

In some implementations, a Wi-Fi access point performs the step of broadcasting a beacon frame. These beacon frames can be a type of management frame in IEEE 802.11 WLANs, transmitted periodically by the access point to announce the presence of the wireless LAN and provide timing synchronization. For asymmetric MLO, the access point can include specific information within the beacon frame relevant to multi-link devices (MLDs). This information can be conveyed via an information element (IE), which can be vendor-specific. Within the IE, the beacon frame can indicate its length using a Length field and can indicate an identity of a vendor of the access point. The IE can include details about the access point's MLO Capabilities, listing the Radio IDs that identify at least two radios which support MLO. A Negotiation Information field can be included, which may contain a Negotiation Status field and can present a proposed assignment of radios for asymmetric MLO by specifying a proposed Downlink Radio ID and a proposed Uplink Radio ID. The access point's readiness and suggested configuration for bidirectional communication over separate links is this broadcast.

The benefits and advantages of the implementations described herein include the operation of a full-duplex-like communication environment. By separating uplink and downlink traffic onto different radio links, the implementations effectively create a full-duplex-like communication environment without the limitations typically associated with half-duplex Wi-Fi systems. This separation reduces the possibility of packet collisions between transmitted and received data, resulting in more efficient use of available bandwidth and reduced latency. The implementations' use of wider bandwidth channels specifically for downlink traffic aligns with typical usage patterns where download bandwidth requirements exceed uplink needs. The implementations improve performance for bandwidth-intensive applications like video streaming and file downloads while maintaining efficient use of spectrum for control signals and acknowledgments. The ability to fall back to traditional operation provides more robust performance even when network conditions change, while the maintenance of a single authentication process across both links simplifies security management and reduces overhead.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

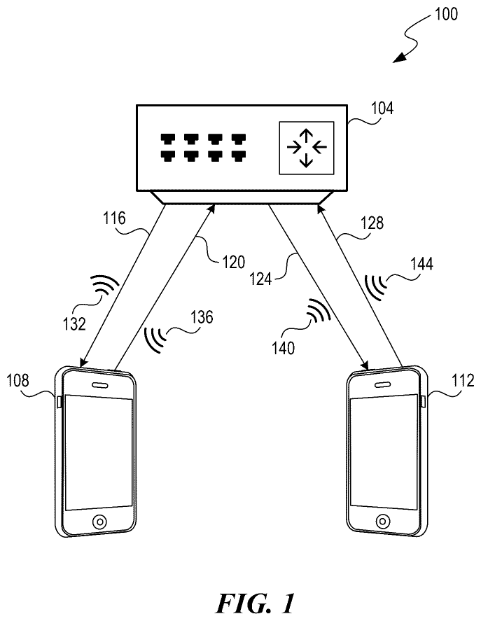

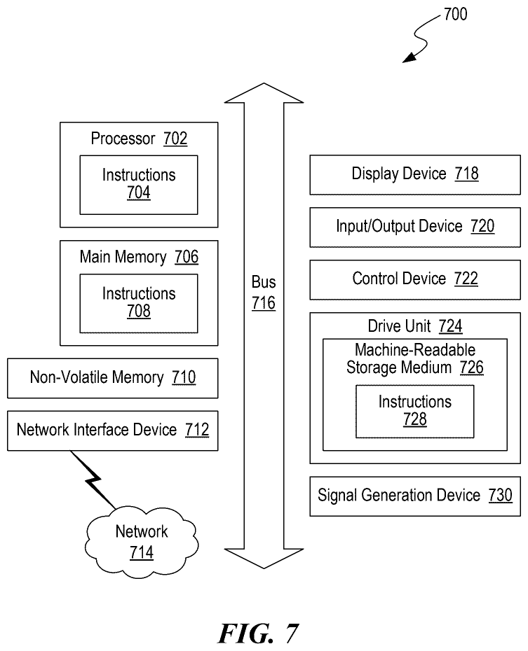

FIG. 1 is a block diagram that illustrates an example system 100 that can implement aspects of the present technology. System 100 includes a Wi-Fi access point 104 and wireless devices 108, 112. The system 100 is implemented using components of example computer system 700 illustrated and described in more detail with reference to FIG. 7. Likewise, embodiments of example system 100 can include different and/or additional components or can be connected in different ways.

The Wi-Fi access point 104 is a networking device that allows the wireless devices 108, 112 to connect to a wired network using Wi-Fi. The Wi-Fi access point 104 can act as a central transmitter and receiver of wireless radio signals, enabling the wireless devices 108, 112 (e.g., laptops, smartphones, tablets, or other Wi-Fi-enabled devices) to communicate with a local network and access the internet. The access point 104 can be connected to a router or switch via Ethernet or the access point 104 can be embedded within a router. The access point 104 bridges the gap between wired infrastructure and wireless users. Multiple dedicated access points may be installed to extend Wi-Fi coverage and manage more users effectively. For example, enterprise-grade access points are usually connected to a central controller or managed through cloud-based platforms for configuration and monitoring. The access point 104 can broadcast a network name, or Service Set Identifier (SSID), that nearby devices 108, 112 can detect. When a user connects to the SSID, the access point 104 authenticates the device (if security settings like WPA3 are enabled) and forwards data between the device and the network.

The access point 104 includes Wi-Fi Multi-Link Operation (MLO) functionality, a feature introduced in Wi-Fi 7(802.11 be) that improves wireless performance, reliability, and efficiency. MLO allows a Wi-Fi device, such as the access point 104 or device 108, to use multiple frequency bands (2.4 GHz, 5 GHz, and/or 6 GHz) simultaneously for data transmission and reception. Instead of being limited to a single band at a time, devices can combine links across different bands to create a unified, high-speed connection. The multi-link approach boosts overall throughput by aggregating bandwidth from multiple links. MLO can further reduce latency by dynamically selecting the fastest and least congested link for each data packet. MLO can also enhance reliability—if one link experiences interference or congestion, traffic can automatically shift to another link without dropping the connection.

The device 108 can be communicably, wirelessly coupled to the access point 104. In some implementations, the access point 104 determines whether device 108 (sometimes referred to as a client device) supports asymmetric MLO. Asymmetric MLO allows devices to use different frequency bands for uplink and downlink traffic. For example, device 108 might download data over band 132 (e.g., 6 GHz band) while uploading over band 136 (e.g., 2.4 or 5 GHz band). In another example, device 108 downloads data over the 5 or 6 GHz band while uploading over the 2.4 GHz band. This flexibility improves performance by designating each direction of traffic based on signal quality, congestion, or interference. For example, the access point 104 and the client device 108 can engage in a handshake process that occurs after establishing a basic multi-link connection using Wi-Fi 7 MLO protocols.

The access point 104 can broadcast Wi-Fi beacon extensions (sometimes referred to as vendor extensions) within its beacon frame or beacon signal. These extensions signal the access point's capability to support the enhanced asymmetric operation, which goes beyond the standard bidirectional MLO. Upon receiving the beacon frame, the device 108 (if it supports these extensions) will recognize the access point's capability for unidirectional communication on designated links. This exchange, sometimes described as an “overlaying handshake,” allows the access point 104 and device 108 to agree on using specific radios for uplink and downlink traffic before the main traffic flow begins.

The Wi-Fi beacon extensions refer to signaling mechanisms optionally implemented on the access point 104 to enable asymmetric MLO. The Wi-Fi beacon extensions can be specific to each different access point vendor or manufacturer. The Wi-Fi beacon extensions can be broadcast by the access point 104 within its beacon frame. The purpose is to signal the access point's capability to support unidirectional communication on designated radio links, allowing for the dedication of specific links for either uplink or downlink traffic. Upon receiving this beacon, a client device 108 that also supports the specific Wi-Fi beacon extensions will recognize the access point's ability to operate asymmetrically. This leads to an “overlaying handshake” between the client 108 and the access point 104, occurring after a basic multi-link connection is established using Wi-Fi 7 MLO protocols. During this handshake, the access point 104 and the client 108 can agree on which radio link will be used for uplink and which for downlink traffic. This negotiation, facilitated by the exchange of the Wi-Fi beacon extensions over the air, allows the system 100 to improve traffic flow by potentially using wider bandwidth bands (like 5 GHz or 6 GHz) for downlink and narrower bands (like 2.4 GHz) for uplink, catering to typical Internet usage patterns with heavier downlink traffic.

The access point 104 establishes a multi-link connection with the device 108 using at least two radio links 116, 120. Similarly, the access point 104 can establish a multi-link connection with the device 112 using radio links 124, 128. The access point 104 and the client device 108 can use Wi-Fi 7 MLO protocols. This allows the device 108 to simultaneously connect to two radios of the access point 104, e.g., on different frequency bands like a first frequency band 132 (e.g., 5 or 6 GHz) and a second frequency band 136 (e.g., 2.4 GHz). The client device 108 does not need to re-authenticate with the access point 104 when using the multiple links 116, 120. The multi-link connection, which enables device 108 to send and receive data across different frequency bands (e.g., frequency bands 132, 136) and channels, is established before the asymmetric traffic distribution is configured. Similarly, another multi-link connection can be established to enables device 112 to send and receive data across different frequency bands (e.g., frequency bands 140, 144) before the asymmetric traffic distribution is configured.

In some implementations, a first frequency band 132 (often utilized for the higher-bandwidth downlink traffic), typically comprises the 6 Gigahertz (GHz) band due to its capacity for greater throughput. The second frequency band 136 (designated for uplink traffic) can be either the 2.4 GHz band or the 5 GHz band. The 2.4 GHz band is often employed for acknowledgments and control signals, while the 5 GHz band can also serve this purpose. In some implementations, the first frequency band 132 can be a 5 or 6 GHz band while the second frequency band 136 is a 2.4 GHz band. This selection of frequency bands with differing characteristics allows for improved usage of network resources based on traffic direction.

To establish a multi-link connection, the access point 104 and client device 108 use at least one Wi-Fi 7 protocol (e.g., MLO). Wi-Fi 7 protocols provide advancements for improved wireless performance. For example, MLO enables devices to simultaneously connect across multiple frequency bands like 2.4 GHz, 5 GHz, and/or 6 GHz, enhancing throughput and reducing latency. Other notable Wi-Fi 7 protocols include wider 320 MHz channels, 096 Quadrature Amplitude Modulation (4096-QAM), and multiple resource units (Multi-RU), all contributing to faster speeds and greater efficiency.

The access point 104 can configure radio link 116 for downlink transmission on frequency band 132 through a negotiation process between the access point 104 and the client device 108. The access point 104, potentially signaling its asymmetric capabilities via Wi-Fi beacon extensions in its beacon, designates one of the available radio links, often the one operating on a wider frequency band such as 5 GHz or 6 GHz, to be exclusively used for downlink traffic from the access point 104 to the client 108. The access point 104 configures a second radio link 120 for exclusive uplink transmission. This configuration involves designating a radio operating on a narrower frequency band 136, such as the 2.4 GHz band, for carrying traffic solely from the client device 108 to the access point 104. This designation, potentially negotiated through Wi-Fi beacon extensions, complements the configuration of the first radio link 116 for downlink, establishing the asymmetric traffic flow.

In some implementations, the access point 104 implements traffic routing rules such that downlink traffic is directed to the designated first radio link 116. The traffic routing rules are network policies that determine how data packets are directed between devices or networks. The rules can guide traffic based on factors like source/destination IP addresses, ports, protocols, or application types. The access point 104 can use the rules to choose the best path for data, providing more efficient, secure, and prioritized communication. For example, the rules can also be used for load balancing, directing traffic through particular links, failover operation, and/or limiting bandwidth for specific devices or services to manage network performance and security. The rules can be managed by the access point's traffic management capabilities and can be used to exclusively route data intended for the client 108, such as streaming media, over the specified downlink radio link 116. Based on the traffic routing rules, the access point 104 configures system 100 such that uplink traffic originating from the client device 108, such as acknowledgements and control signals, is exclusively directed to the configured second radio link 120. This routing decision is also part of the negotiated asymmetric communication established, enabling a dedicated path for transmissions from the client 108 to the access point 104.

The access point 104 can monitor performance metrics of the downlink and/or uplink radio links 116, 120 after establishing the asymmetric MLO. The monitoring can be periodic, continuous, or ongoing in some other manner. The ongoing assessment enables the system 100 to track the quality and reliability of each connection. The monitoring process enables the access point 104 to detect issues such as interference or link degradation on either the wider bandwidth downlink link 116 or the narrower bandwidth uplink link 120. The evaluation of link performance improves data transmission and can trigger failover mechanisms if a link becomes unavailable. The performance metrics can include throughput (e.g., 300 Megabits per second (Mbps)), latency (e.g., 20 milliseconds (ms)), signal strength (e.g., −50 decibel-milliwatts (dBm)), packet loss (e.g., 0.5%), and/or jitter (e.g., 5 ms). The metrics can be used to assess network speed, reliability, and/or user experience. For example, low latency and high throughput are important for gaming or video streaming, while low packet loss provides smoother communication and data integrity.

The access point 104 and client device 108 can engage in bidirectional communication by simultaneously using the separate links 116, 120. Downlink traffic, such as streaming media, is exclusively routed to the first radio link 116, often operating on a wider 5/6 GHz band, while uplink traffic, including acknowledgements and control signals, is solely directed to the second radio link 120, potentially on the 2.4 GHz band. The separation, facilitated by traffic routing rules, enables a full-duplex-like operation, improving efficiency by avoiding collisions inherent in traditional half-duplex systems. In some implementations, the access point 104 handles downlink traffic associated with high-bandwidth applications by leveraging the traffic routing rules. The rules can be designed to automatically direct data for applications like streaming media content to the first radio link 116. For example, the access point 104 recognizes the nature of the traffic and routes it via the designated, higher-capacity downlink path. During asymmetric MLO, the second radio link 120 can be used to transmit control signals and/or acknowledgement messages from the client device 108 to the access point 104.

When a failure of a radio link (e.g., link 116) is detected within the asymmetric MLO, the access point 104 can perform an operation to provide ongoing communication. The access point 104 identifies the unavailable link 116, e.g., by monitoring the performance metrics of both the designated downlink and uplink radio links 116, 120. In response to the failure, the system 100 can dynamically transition to a traditional bidirectional communication mode using the remaining operational radio link (e.g., link 120). Instead of having separate links for strictly downlink or uplink traffic, the client 108 and access point 104 communicate bidirectionally over the single available connection (e.g., link 120), similar to standard Wi-Fi operation. This failover mechanism maintains connectivity despite the link disruption. The access point 104 continues to monitor the status of the failed link 116 and can revert to the more efficient asymmetric operation once the link 116 becomes available again.

In some implementations, during asymmetric MLO, the access point 104 coordinates timing between the designated downlink and uplink radio links 116, 120. The coordination provides more seamless separation of traffic and more efficient communication despite using different frequency bands 132, 136. For example, while operating asymmetrically, the access point 104 manages the flow of data on both links 116, 120 to avoid conflicts and maintain a synchronized communication environment. The timing coordination between the links improves how the devices 108, 112 synchronize and communicate across multiple frequency bands. The timing coordination enables data packets to be transmitted and received more efficiently without collisions or delays for maintaining low latency and high throughput. For example, when using both 5 GHz and 6 GHz links, the access point 104 aligns timing to balance traffic and avoid interference, for more seamless, reliable performance in high-speed or latency-sensitive applications. The timing coordination can be implemented during the initial handshake to establish the unidirectional communication on each link 116, 120.

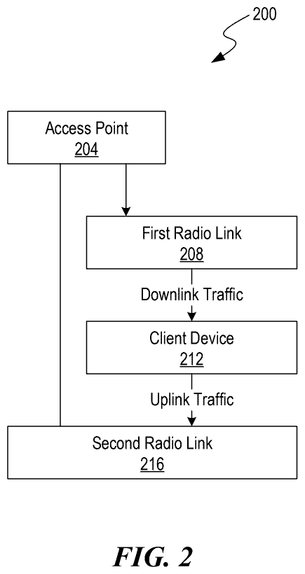

FIG. 2 is a block diagram that illustrates an example system 200 that can implement aspects of the present technology. System 200 includes an access point 204, a first radio link 208, a client device 212, and a second radio link 216. The system 200 is implemented using components of example computer system 700 illustrated and described in more detail with reference to FIG. 7. Likewise, embodiments of example system 200 can include different and/or additional components or can be connected in different ways.

The access point 204 is the same as or similar to the access point 104 illustrated and described in more detail with reference to FIG. 1. The system 200 enables the access point 204 to leverage MLO for asymmetric traffic distribution. FIG. 2 depicts a wireless network setup that separates uplink and downlink traffic onto different radio links 208, 216 to create a full-duplex-like communication environment. The access point 204 is equipped with MLO capability and connects to the client device 212 that also supports MLO functionality. The access point 204 incorporates two distinct radio interfaces-a higher bandwidth (e.g., 5 or 6 GHz) radio and a lower bandwidth (e.g., 2.4 GHz) radio. These radios are configured to operate in a unidirectional manner, e.g., the 5 or 6 GHz radio can be dedicated for downlink transmission from the access point 204 to the client device 212, while the 2.4 GHz radio handles uplink traffic from the client device 212 to the access point 204.

System 200 implements asymmetric MLO. The access point 204 establishes a multi-link connection with the client device 212 using at least two radio links operating at different frequency bands (first radio link 208 and second radio link 216). The first radio link 208, configured to operate at a first frequency band (typically 5 or 6 GHz), is designated exclusively for downlink transmission. The second radio link 216, operating at a second frequency band (e.g., 2.4 GHz), is dedicated to uplink transmission. This separation creates distinct paths for data flow, with downlink traffic restricted to the first radio interface and uplink traffic confined to the second radio interface. System 200 enables simultaneous bidirectional communication through separated uplink and downlink transmissions, effectively creating a full-duplex-like environment without the traditional limitations of half-duplex Wi-Fi systems. The higher bandwidth band (e.g., 5 or 6 GHz) can specifically be used for download-intensive applications like streaming services, while the smaller bandwidth bands handle acknowledgments and control signals. The disclosed implementations address typical usage patterns where download bandwidth requirements significantly exceed uplink needs.

The access point 204 can incorporate traffic management capabilities, implementing traffic routing rules to direct downlink traffic to the first radio link 206 and uplink traffic to the second radio link 216. The system 200 maintains simultaneous transmission and reception across the radio interfaces while coordinating quality of service parameters across both links. The quality-of-service parameters can be used to prioritize network traffic to ensure improved performance for different applications. The parameters can include traffic class, bandwidth allocation, latency, jitter, and/or packet loss. The implementations disclosed herein can assign priority levels to data types—like giving voice or video calls higher priority over file downloads. For example, Wi-Fi Multimedia (WMM) defines four access categories: voice, video, best effort, and background. The implementations disclosed herein can maintain smooth performance for time-sensitive services even during network congestion. The coordination provides improved performance for various applications, particularly benefiting high-bandwidth services like streaming media content on the downlink path while efficiently handling acknowledgment messages on the uplink path.

The client device 212, equipped with corresponding radio interfaces, maintains simultaneous connections with the access point 204 through both links 208, 216. The system 200 can implement a single authentication process for both radio links while operating them asymmetrically, simplifying security management while maintaining robust performance. For example, after the multi-link connection is established, the client device 212 is authenticated for bidirectional communication across both the designated downlink and uplink links 208, 216. Even with the traffic separated, the initial authentication covers both radio interfaces. Moreover, the system 200 includes failover mechanisms that enable transitioning to bidirectional communication on a single radio link if one radio link becomes unavailable, to maintain connectivity.

The system 200 can monitor performance metrics of both radio links 208, 216 and can dynamically adapt to changing network conditions. Separate authentication and security protocols can be maintained for each radio interface while coordinating timing between the links to provide more seamless operation. The disclosed implementations also provide compatibility with existing Wi-Fi infrastructure and the ability to adapt to different usage patterns. The wider bandwidth of the 6 GHz band can be used specifically for downloads while using smaller bandwidth bands for acknowledgments and handshakes. The separation of uplink and downlink traffic onto different radio links prevents packet collisions typically present in half-duplex Wi-Fi systems, resulting in more efficient use of available bandwidth and reduced latency.

The access point 204 can also handle congestion on links in the asymmetric MLO. For example, the access point 204 keeps track of the congestion levels on the radios it is operating on. Based on this information, the access point 204 can dynamically change which radio link is used for uplink versus downlink. For instance, if the designated uplink channel (e.g., 2.4 GHz) becomes congested, the access point 204 can use the 5 GHz band for uplink and the 6 GHz band for downlink, or vice versa, if the 5 or 6 GHz bands experience congestion. This dynamic allocation can be facilitated through signaling between the client device 212 and the access point 204. The Wi-Fi beacon extensions exchanged over the air enable the access point 204 and client device 212 to designate the uplink and downlink radios.

Further, if a designated radio link experiences interference, the access point 204 can dynamically change which radio link is used for uplink versus downlink. For example, if the 2.4 GHz band, designated for uplink, experiences interference, the access point 204 can use the 5 GHz or 6 GHz band for uplink instead. The asymmetric MLO implementations disclosed herein mitigate network interference and traffic congestion by enabling devices to utilize multiple frequency bands and improving traffic flow based on link conditions. Moreover, the access point 204 can fall back to standard bidirectional communication on a healthy link if a dedicated asymmetric link becomes unusable due to interference.

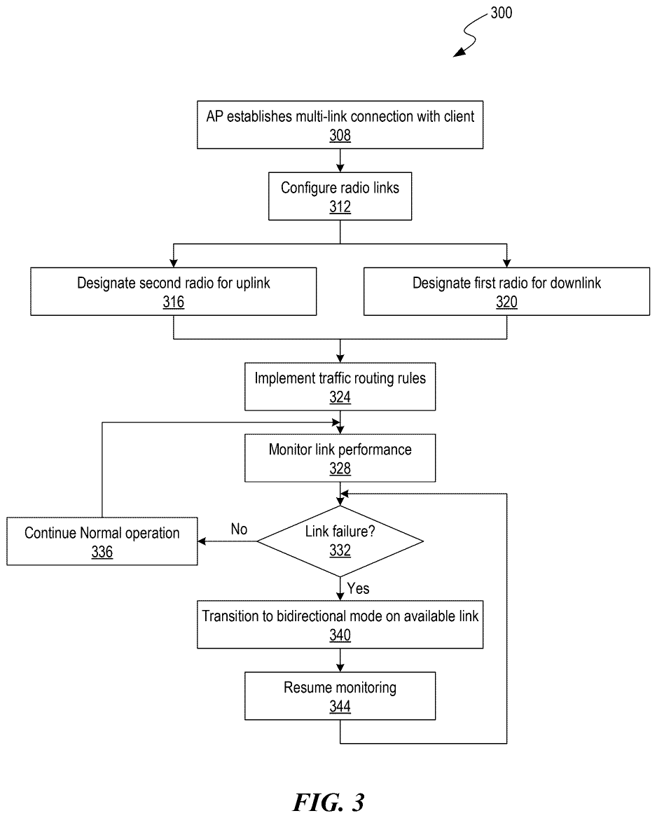

FIG. 3 is a flow diagram that illustrates an example process 300 that performs aspects of the present technology. The flow diagram illustrates the operational sequence of a wireless communication system that implements asymmetric MLO to enhance Wi-Fi performance. The diagram outlines the key steps involved in establishing, maintaining, and managing a wireless connection that separates uplink and downlink traffic onto different radio links, creating an efficient full-duplex-like communication environment. In some implementations, the process 300 is performed by the system 200 illustrated and described in more detail with reference to FIG. 2. In some implementations, the process 300 is performed by a computer system, e.g., computer system 700 illustrated and described in more detail with reference to FIG. 7. Particular entities, for example, an access point perform some or all of the steps of the process in other implementations. Likewise, implementations can include different and/or additional steps or can perform the steps in different orders.

At 308, an access point establishes a multi-link connection with a client device (e.g., using Wi-Fi 7 MLO protocols). The multi-link connection is established between the access point and a client device using at least two radio links. This connection phase can include detecting the client device's capability to support asymmetric MLO and/or establishing the connection using WiFi 7 multi-link operation protocols. At 312, at least two radio links are configured. In this configuration phase, a first radio link operating at a first frequency band is configured for downlink transmission and a second radio link operating at a second frequency band is configured for uplink transmission. For example, at 316 a second radio (e.g., a 2.4 GHz radio) is designated specifically for uplink transmission. At 320, a first radio (e.g., a 5 or 6 GHz radio) is designated for downlink transmission.

At 324, traffic routing rules are implemented to direct the appropriate traffic types to each designated radio link. The traffic routing rules enforce the asymmetric traffic distribution. For example, the rules direct downlink traffic, such as streaming media content and high-bandwidth applications, exclusively to the first radio link while routing uplink traffic, including acknowledgment messages and control signals, to the second radio link. This separation improves network efficiency by using the larger bandwidth of the 6 GHz band specifically for downloads while leveraging smaller bandwidth bands for uploads and control traffic. Simultaneous bidirectional communication is maintained through the separated uplink and downlink transmissions, creating a full-duplex-like environment without the traditional limitations of half-duplex Wi-Fi systems. Network efficiency is improved by preventing packet collisions typically present in half-duplex Wi-Fi systems, resulting in more efficient use of available bandwidth and reduced latency.

At 328, a periodic or continuous monitoring phase begins where link performance is checked. In the monitoring phase, performance metrics of both radio links are assessed. The monitoring enables quality of service to be maintained across both links while providing improved performance for various applications. For example, quality of service parameters can be coordinated across both radio links, enabling high-bandwidth applications to receive appropriate prioritization on the downlink path while maintaining efficient handling of control traffic on the uplink path. The implementations also address practical deployment scenarios, including compatibility with existing Wi-Fi infrastructure and the ability to adapt to different usage patterns. Timing between links can be coordinated while separate authentication and security protocols can be maintained for each radio interface while operating them asymmetrically.

At 336, the access point continues to engage in normal operation in the absence of link failure. At 340, the access point can transition to bidirectional mode on an available link if a link failure occurs (at 332) and renders another link unavailable. Uninterrupted connectivity is provided while maintaining the ability to resume normal asymmetric operation when conditions permit. The disclosed systems can handle link failures gracefully. When a link failure is detected, the failover mechanisms implemented enable transitioning to bidirectional communication on a single available radio link. This transition process includes maintaining separate authentication and security protocols while maintaining connectivity. Performance in this fallback mode is monitored and the access point can seamlessly return to asymmetric operation when both links become available again.

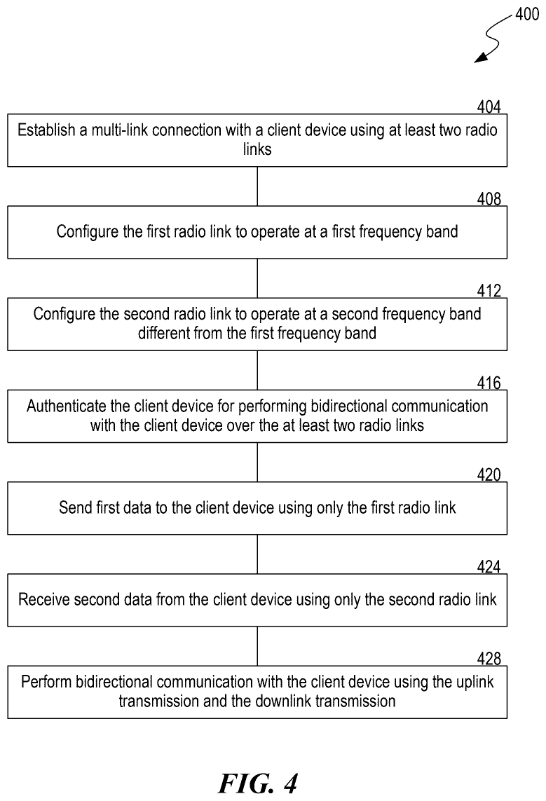

FIG. 4 is a flow diagram that illustrates an example process that performs aspects of the present technology. In some implementations, the process is performed by the system 200 illustrated and described in more detail with reference to FIG. 2. In some implementations, the process is performed by a computer system, e.g., example computer system 700 illustrated and described in more detail with reference to FIG. 7. Particular entities, for example, an access point perform some or all of the steps of the process in other implementations. Likewise, implementations can include different and/or additional steps or can perform the steps in different orders.

At 404, an access point (e.g., access point 104 shown by FIG. 1) establishes a multi-link connection with a compatible client device (e.g., device 108 shown by FIG. 1) using at least two radio links by initiating a Wi-Fi 7 MLO connection. The multi-link connection can be established using at least one MLO protocol. For example, the MLO protocols used can include simultaneous transmit and receive (STR) for parallel link use, asynchronous MLO (enabling independent link scheduling), synchronous MLO (where links are tightly coordinated), link aggregation (which improves throughput), and/or load balancing for improved traffic distribution. These protocols boost speed, reliability, and latency, and are beneficial for AR/VR, gaming, and high-bandwidth applications. The established multi-link connection enables simultaneous communication across different frequency bands. The access point and client device can engage in a handshake process, potentially involving the exchange of Wi-Fi beacon extensions, to designate a first radio link (operating on a first frequency band), often a wider bandwidth such as 5 or 6 GHz, specifically for downlink transmission. A second radio link operating on a second frequency band, possibly a 2.4 GHz band, is designated for uplink transmission, creating an asymmetric communication setup. In some implementations, the first frequency band is one of a 5 GHz band or a 6 GHz band, and the second frequency band is a 2.4 GHz band.

At 408, the access point configures the first radio link to operate on a first frequency band. This configuration often involves selecting a frequency band having a greater bandwidth such as the 5 GHz or 6 GHz band. The first radio link can be configured to operate on a specific frequency band using the access point's firmware or controller settings. During setup, the access point assigns each radio a band and a channel within that band based on regulatory rules, interference, and network design. The client device scans and connects to the appropriate SSID broadcast on that band. The access point designates a first radio interface to utilize the chosen first frequency spectrum, e.g., for the anticipated high-throughput downlink traffic.

At 412, the access point configures the second radio link to operate on a second frequency band that is different from the first. This can involve selecting either the 2.4 GHz band or the 5 GHz band. The configuration designates the operational frequency spectrum for the second radio interface, which is commonly intended for the transmission of uplink traffic, such as acknowledgments and control signals, contrasting with the first link's frequency band. The first radio link has a greater first bandwidth. This higher bandwidth is strategically used for the high-throughput downlink transmission. Conversely, the second radio link has a smaller second bandwidth and is typically employed for the less demanding uplink transmission.

At 416, the access point employs a single authentication process to authorize the client device for communication across both radio links involved in the asymmetric MLO. After the establishment of the multi-link connection, the client device undergoes an authentication procedure, granting it the ability to send and receive data in a predominantly unidirectional manner over the designated links. This single authentication simplifies security management and reduces overhead for the client device. Even though one link is primarily used for downlink and the other for uplink, the authentication covers the client's access rights across both radio interfaces. The access point maintains this authentication state, allowing for seamless bidirectional communication if a link failure necessitates a transition to traditional operation.

At 420, the access point sends first data to the client device using only the first radio link. The first radio link has been configured to operate at a first frequency band, often a wider bandwidth channel such as 5 GHz or 6 GHz, to accommodate high-throughput downlink traffic. The access point implements traffic routing rules such that data intended for the client, such as streaming media content, is directed solely to this designated downlink radio link. This unidirectional transmission on the first radio link leverages its greater capacity for efficient delivery of data from the access point to the client device.

At 424, the access point receives second data from the client device using only the second radio link. The second radio link has been specifically designated for uplink transmission from the client device to the access point. The second radio link operates on a second frequency band, which is different from (and has smaller bandwidth than) the first downlink link. The second radio link can be a 2.4 GHz or 5 GHz band. The second radio link carries data originating from the client device. Traffic routing rules are used such that transmissions from the client device are directed to the designated uplink radio link, which has a smaller bandwidth compared to the downlink link.

At 428, the access point performs bidirectional communication with the client device using the simultaneous operation of the separated uplink and downlink transmissions. The access point sends data to the client device using only the first radio link, which is configured for downlink on a specific frequency band. Concurrently, the access point receives data from the client device using only the second radio link, designated for uplink transmission on a different frequency band. In some cases, the downlink transmission includes streaming media content, and the uplink transmission includes acknowledgment messages.

In some implementations, in the event that the first radio link becomes unavailable due to interference or other issues, the access point implements a failover mechanism to maintain continuous connectivity. The access point detects the link failure and dynamically transitions to perform bidirectional communication using only the second radio link. This transition implies a shift from the asymmetric operation (in which traffic is separated) to a more traditional Wi-Fi mode on the remaining available link. The client device does not need to re-authenticate during this transition because of the established multi-link connection. The access point will continue to monitor the performance of the remaining link and can revert to asymmetric operation once the first radio link becomes available again.

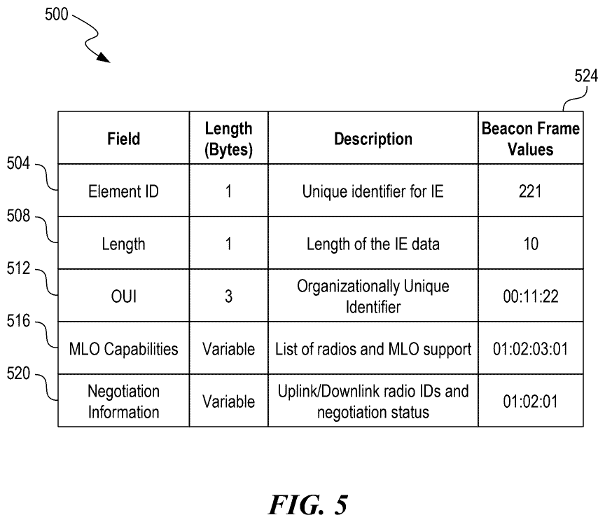

FIG. 5 is a drawing of a table 500 that illustrates example Wi-Fi beacon extensions. Table 500 includes an Element ID field 504, a Length field 508, an Organizationally Unique Identifier (OUI) field 512, an MLO Capabilities field 516, and a Negotiation Information field 520. Likewise, embodiments of the example Wi-Fi beacon extensions format can include different and/or additional fields or can be arranged in different ways.

FIG. 5 also shows example values for the different fields of an IE within a beacon frame 524. The Element ID field 504 identifies an IE included in a beacon frame, e.g., beacon frame 524. The Element ID field 504 is a unique identifier, e.g., for a vendor-specific IE, and enables the client device to identify the IE's purpose (or that the IE is present) within the beacon frame 524. An example value of a vendor-specific IE in the beacon frame 524 shown by FIG. 5 is 221. The Length field 508 is used by the beacon frame 524 to indicate a length of the IE data, e.g., 10 Bytes. The OUI field 512 (typically 3 Bytes long) identifies a vendor or manufacturer. In beacon frame 524, the value 00:11:22 is an example OUI for a particular vendor. The MLO Capabilities field 516 can include identifiers of at least two radios (listed as Radio IDs, e.g., 01, 02, 03) that support MLO. The MLO Capabilities field 516 can also include an MLO Support indicator, e.g., 01 (MLO supported). The Negotiation Information field 520 is used in the negotiation process between the access point and the client device for determining the first radio for downlink transmission and the second radio for uplink transmission. The Negotiation Information field can include an Uplink Radio ID field proposing the radio 01 for uplink, a Downlink Radio ID field for the proposed downlink radio 02, and a Negotiation Status field indicating the negotiation's state (e.g., “01—In progress”). The field's length can be variable.

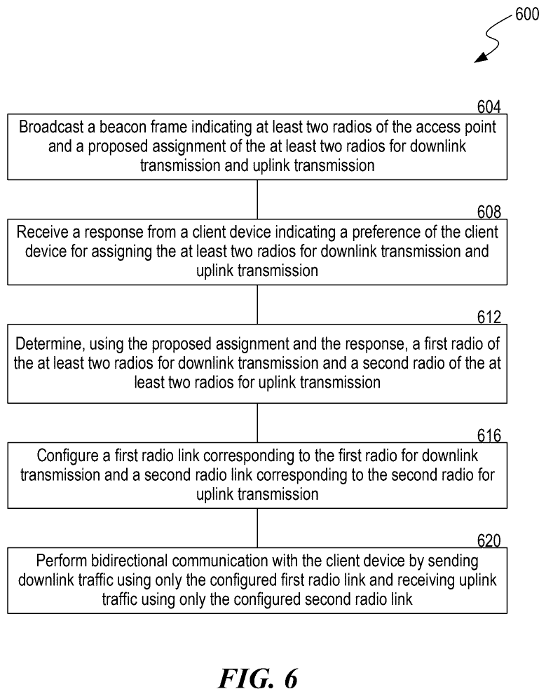

FIG. 6 is a flow diagram that illustrates an example process that performs aspects of the present technology. In some implementations, the process is performed by the system 200 illustrated and described in more detail with reference to FIG. 2. In some implementations, the process is performed by a computer system, e.g., example computer system 700 illustrated and described in more detail with reference to FIG. 7. Particular entities, for example, an access point perform some or all of the steps of the process in other implementations. Likewise, implementations can include different and/or additional steps or can perform the steps in different orders.

At 604, an access point broadcasts a beacon frame indicating at least two radios of the access point and a proposed assignment of the at least two radios for downlink transmission to a client device and uplink transmission from the client device. For example, the access point (that supports asymmetric MLO) performs the step of broadcasting a beacon frame. This beacon frame can include an information element (IE), which may be vendor-specific or manufacturer-specific and is sometimes referred to as a Wi-Fi beacon extension. The IE can signal the access point's capability for enhanced asymmetric operation. The IE can define the access point's MLO capabilities, e.g., listing identifiers of the access point's radios that support MLO. The IE can be added to the standard beacon frame structure to carry information related to MLO. The beacon frame can include negotiation information with a proposed Uplink Radio ID and a proposed Downlink Radio ID, indicating the access point's suggested assignment of its radios for dedicated downlink transmission to and uplink transmission from a client device.

In some implementations, within the IE's format, the beacon frame indicates a length of the information element via a Length field (which can be 1 byte). This field specifies the IE data's length. Within the IE's MLO Capabilities section, the beacon frame can include identifiers of at least two radios. These radio IDs indicate which radios support MLO. The IE can include an Organizationally Unique Identifier (OUI) field that indicates an identity of a vendor or a manufacturer of the access point. Within the IE, the beacon frame indicates that the at least two radios support MLO (e.g., signaled in an “MLO Capabilities” section, potentially listing radio IDs and an “MLO Support” field).

At 608, the access point receives a response from the client device indicating a preference of the client device for assigning the at least two radios for downlink transmission and uplink transmission. For example, after the access point broadcasts its asymmetric MLO capabilities and proposed radio assignments, a compatible client device receives and processes this information. As part of a negotiation process, sometimes described as an “overlaying handshake,” the client device sends a response to the access point. The response indicates the preference of the client device for assigning the at least two radios for downlink transmission and uplink transmission (i.e., which of the at least two radios the client device would prefer for downlink transmission and which of the at least two radios the client device would prefer for uplink transmission). The response can include or be part of an association request frame, facilitating an agreement on which specific radio links will be used for dedicated unidirectional traffic flow.

In some implementations, the multi-link setup process reuses existing standard association request/response frames and adds an extra Multi-Link Element (MLE) to them. The association, along with authentication and setup, can take place as a common management function at the Upper MAC (U-MAC) layer. Additionally, when connecting to a hidden Service Set Identifier (SSID), the client device specifies the SSID name in the association frame it sends to the access point. In some implementations, the information in the IE can change and be re-broadcast. For example, the IE can include a Negotiation Status field, which indicates a status of a negotiation with the client device for determining the first radio for downlink transmission and the second radio for uplink transmission. The updated IE can be sent to the client device in an association response frame.

At 612, the access point determines, using the proposed assignment and the response, a first radio of the at least two radios for downlink transmission and a second radio of the at least two radios for uplink transmission. For example, the access point performs the step of determining an assignment of which radio to use for uplink or downlink, utilizing both its initial proposed assignment from the beacon and the client's indicated preference of radios from the response. The selection of the first radio specifically for downlink transmission and the second radio specifically for uplink transmission is finalized, completing the asymmetric MLO negotiation.

At 616, the access point configures, based on the results of act 612, a first radio link corresponding to the first radio for downlink transmission and a second radio link corresponding to the second radio for uplink transmission. Act 612 results in a finalized assignment derived from the access point's proposed assignment (potentially via Wi-Fi extensions in a beacon frame) and the client device's response. The access point performs the configuration of the radio links. This involves setting up the first radio link corresponding to the first radio for downlink transmission (e.g., dedicating a wider frequency band like 5 GHz or 6 GHz exclusively for traffic from the access point to the client). Concurrently, the access point configures a second radio link corresponding to the second radio for uplink transmission, typically assigning a narrower frequency band like 2.4 GHz for traffic solely from the client device to the access point. This configuration, facilitated by the negotiation process potentially using the extensions, establishes the asymmetric traffic flow.

In some implementations, the access point configures a radio link by assigning a frequency band to the radio link. The access point can also select the frequency band based on several factors, including device compatibility, network congestion, and interference levels. Once the frequency band is selected, the access point assigns the radio link to one of its internal radios. The access point determines whether the selected radio is overloaded and can maintain a stable connection. Quality of Service (QoS) and the number of active clients per radio to balance the load can also be considered. After the assignment, the access point configures the radio link's parameters—such as channel, power level, and security settings—to improve performance and compliance with local regulations. This dynamic configuration enables the access point to maintain reliable, high-performance wireless connections while adapting to changes in the environment and client device behavior. In some implementations, the access point can enhance network efficiency and user experience using intelligent band steering and load balancing.

The access point establishes a multi-link connection with the client device using the configured first radio link and the configured second radio link. This establishment leverages Wi-Fi 7 MLO protocols and solidifies the multi-link setup, now specifically utilizing the first radio link, configured for downlink transmission (potentially on a wider 5 or 6 GHz band), and the second radio link, configured for uplink transmission (possibly on a narrower 2.4 GHz band), based on the prior determination.

At 620, the access point performs bidirectional communication with the client device by sending downlink traffic to the client device using only the configured first radio link and receiving uplink traffic from the client device using only the configured second radio link. Following the asymmetric MLO negotiation, the access point performs bidirectional communication with the client device. The access point sends downlink traffic to the client device using only the configured first radio link, which is typically operating on a wider frequency band such as 5 GHz or 6 GHz, suitable for high-throughput data like streaming media. Simultaneously, the access point receives uplink traffic from the client device using only the configured second radio link, often on a narrower band like 2.4 GHz, for traffic such as acknowledgment messages or control signals. This strict separation, facilitated by traffic routing rules, creates a full-duplex-like communication environment.

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, video display device 718, an input/output device 720, a control device 722 (e.g., keyboard and pointing device), a drive unit 724 that includes a storage medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computer system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 700. In some implementation, the computer system 700 can be an embedded computer system, a system-on-chip (SOC), a single-board computer system (SBC) or a distributed system such as a mesh of computer systems or include one or more cloud components in one or more networks. Where appropriate, one or more computer systems 700 can perform operations in real-time, near real-time, or in batch mode.

The network interface device 712 enables the computer system 700 to mediate data in a network 714 with an entity that is external to the computer system 700 through any communication protocol supported by the computer system 700 and the external entity. Examples of the network interface device 712 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computer system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computer system 700 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the examples, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following examples should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the examples. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. An access point comprising:
at least one hardware processor; and
at least one non-transitory memory storing instructions, which, when executed by the at least one hardware processor, cause the access point to:
establish a multi-link connection with a client device using at least two radio links,
wherein a first radio link of the at least two radio links is used for downlink transmission, and
wherein a second radio link of the at least two radio links is used for uplink transmission;
configure the first radio link to operate at a first frequency band;
configure the second radio link to operate at a second frequency band different from the first frequency band;
authenticate the client device for performing bidirectional communication with the client device over the at least two radio links;
send first data to the client device using only the first radio link;
receive second data from the client device using only the second radio link; and
perform bidirectional communication with the client device using the uplink transmission and the downlink transmission,
wherein the uplink transmission is separated from the downlink transmission.

2. The access point of claim 1, wherein the first frequency band comprises one of a 5 Gigahertz (GHz) band or a 6 GHz band, and
wherein the second frequency band comprises a 2.4 GHz band.

3. The access point of claim 1, wherein the first radio link has a first bandwidth, and
wherein the second radio link has a second bandwidth, and
wherein the first bandwidth is greater than the second bandwidth.

4. The access point of claim 1, wherein the access point is caused to:
determine that the first radio link is unavailable; and
perform the bidirectional communication using only the second radio link.

5. The access point of claim 1, wherein the downlink transmission comprises streaming media content, and
wherein the uplink transmission comprises acknowledgment messages.

6. The access point of claim 1, wherein the access point is caused to:
coordinate quality of service parameters for the at least two radio links; and
monitor performance metrics of the at least two radio links.

7. The access point of claim 1, wherein the multi-link connection is established using at least one multi-link operation protocol.

8. At least one non-transitory computer-readable storage medium storing instructions, which, when executed by at least one data processor of a computer system, cause the computer system to:
determine that a client device, that is communicably coupled to the computer system, supports asymmetric multi-link operation;
establish a multi-link connection with the client device using at least two radio links;
configure a first radio link of the at least two radio links for downlink transmission,
wherein the first radio link operates at a first frequency band;
configure a second radio link of the at least two radio links for exclusive uplink transmission,
wherein the second radio link operates at a second frequency band;
direct downlink traffic to the first radio link using one or more traffic routing rules;
direct uplink traffic to the second radio link using the one or more traffic routing rules;
monitoring performance metrics of the at least two radio links; and
perform bidirectional communication with the client device using the first radio link and the second radio link,
wherein the downlink traffic is separated from the uplink traffic.

9. The non-transitory computer-readable storage medium of claim 8, wherein the downlink traffic is associated with a high-bandwidth application.

10. The non-transitory computer-readable storage medium of claim 8, wherein the uplink traffic comprises control signals.

11. The non-transitory computer-readable storage medium of claim 8, wherein the multi-link connection uses at least one Wi-Fi 7 protocol.

12. The non-transitory computer-readable storage medium of claim 8, wherein the computer system is caused to perform at least one operation in response to a failure of a radio link of the at least two radio links.

13. The non-transitory computer-readable storage medium of claim 8, wherein the computer system is caused to coordinate timing between the at least two radio links.

14. The non-transitory computer-readable storage medium of claim 8, wherein the first frequency band comprises a 6 Gigahertz (GHz) band, and
wherein the second frequency band comprises one of a 2.4 GHz band or a 5 GHz band.

15. A method performed by a computer system, the method comprising:
determining that a client device, that is communicably coupled to the computer system, supports asymmetric multi-link operation;
establishing a multi-link connection with the client device using at least two radio links;
wherein a first radio link of the at least two radio links operates at a first frequency band, and
wherein a second radio link of the at least two radio links operates at a second frequency band;
directing downlink traffic to the first radio link;
directing uplink traffic to the second radio link; and
performing bidirectional communication with the client device using the first radio link and the second radio link,
wherein the downlink traffic is separated from the uplink traffic.

16. The method of claim 15, wherein the first radio link has a first bandwidth, and
wherein the second radio link has a second bandwidth less than the first bandwidth.

17. The method of claim 15, comprising:
determining that the first radio link is unavailable; and
performing the bidirectional communication using the second radio link.

18. The method of claim 15, comprising:
coordinating quality of service parameters for the at least two radio links; and
monitoring performance metrics of the at least two radio links.

19. The method of claim 15, comprising:
coordinating timing between the at least two radio links.

20. The method of claim 15, comprising:
authenticating the client device for performing the bidirectional communication.

21.-29. (canceled)
